(19) United States
(12) Patent Application Publication
(10) Pub. No.: US 2011/0014365 A1
(43) Pub. Date: Jan. 20, 2011

(54) DEVICE AND ITS MANUFACTURING METHOD, ELECTRO-OPTICAL DEVICE AND ITS MANUFACTURING METHOD, AND ELECTRONIC EQUIPMENT

(75) Inventor: Kei HIRUMA, Chino (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/887,124

(22) Filed: Sep. 21, 2010

Related U.S. Application Data
(62) Division of application No. 11/337,561, filed on Jan. 24, 2006.

(30) Foreign Application Priority Data
Jan. 26, 2005 (JP) 2005-017954

(51) Int. Cl. B05D 5/06; B29C 70/88

(52) U.S. Cl. 427/162

(57) ABSTRACT

A manufacturing method of a device having a pair of substrates fixed together with a sealing material being interposed therebetween includes ejecting a liquid on one of the substrates to form a film of the liquid in a first region disposed inside of a sealing part where the sealing material is disposed. The ejecting of the liquid includes ejecting the liquid so that an edge of the film is disposed inwardly of the sealing part and outwardly of the first region after the film is dried.

### CROSS-REFERENCE TO RELATED APPLICATION

This application is a divisional application of U.S. patent application Ser. No. 11/337,561 filed on Jan. 24, 2006. The entire disclosure of U.S. patent application Ser. No. 11/337,561 is hereby incorporated herein by reference. This application also claims priority to Japanese Patent Application No. 2005-017954, filed Jan. 26, 2005. The entire disclosure of Japanese Patent Application No. 2005-017954 is hereby incorporated herein by reference.

### BACKGROUND

1. Technical Field

The present invention relates to a device and its manufacturing method, electro-optical device and its manufacturing method, and electronic equipment.

2. Related Art

Alignment films for arranging liquid crystal molecules in a liquid crystal display device are coated and formed by the flexography method or the spin coating method. In recent years, the use of droplet ejection method (droplet ejection device) has been studied for forming alignment films including alignment film forming materials by ejecting droplets from the ejection head with the aim of reducing materials and achieving high quality.

When drying the thin film formed by multiple droplets that have been ejected in thin film formation methods using such a droplet ejection method, the drying rate varies between the liquid at the edges of the thin film and the liquid at the center of the thin film. More specifically, the liquid at the edges of the thin film dry faster than the liquid at the center of the thin film. During the drying process, the solid in the liquid flows in the edges where the drying rate is higher, and as a result, a raised thin film is formed at the edges.

Japanese Unexamined Patent Application, First Publication No. 2003-126760 describes the technology for formation of uniform film by the formation of a bank on the substrate corresponding to the contour of the coated area (film formation region) before ejection of liquid, disposing the liquid within the area enclosed by the bank, and inhibiting the rise of coated film at the edges that occurs upon drying.

In the related art heretofore mentioned, productivity may decrease with the increase in the processes because the process of formation of bank becomes necessary. Also, there is a possibility of dissolution of the bank member because of contact between the coated film (ejected liquid) and the bank.

### SUMMARY

An advantage of some aspects of the invention is to provide a device having a uniform and high quality film.

The first aspect of the present invention is a manufacturing method of a device having a pair of substrates fixed together with a sealing material being interposed therebetween includes ejecting a liquid on one of the substrates to form a film of the liquid in a first region disposed inside of a sealing part where the sealing part is formed. The ejecting of the liquid includes ejecting the liquid so that an edge of the film is disposed inwardly of the sealing part and outwardly of the first region after the film is dried.

In the above described method, the ejecting of the liquid may include ejecting the liquid so that the liquid does not enter the sealing part, ejecting the liquid so that a raised part of the film is formed at the edge of the film at a position inward of the sealing part and outward of the first region by drying the film, ejecting the liquid over a region of the one of the substrates having an area that is 1.3 times or larger than that of the first region, and/or ejecting the liquid to entirely cover the first region.

If the area on the substrate on which liquid is disposed is less than 1.3 times the area of the first region on the substrate, film quality was confirmed to deteriorate because of inconsistent drying of the first region. Therefore, the liquid was disposed in the region having an area greater than 1.3 times the area of the first region, so that the rise in the film due to drying occurred outside the first region, and the deterioration in film quality in the first region was prevented. Furthermore, the adverse effects that occur when the liquid reaches the sealing part are avoided because the liquid is disposed further inside of the sealing part.

Moreover, productivity is improved by eliminating the process required for bank formation, and deterioration in film quality because of interaction due to contact with the bank is avoided.

It is preferable that the liquid cover the first region by the ejected liquid, from the viewpoint of acquisition of specific characteristics of the device.

Use of the film formation region as display region is also feasible.

Another aspect of the present invention is a manufacturing method of an electro-optical device with a film formed on a substrate, wherein the aforementioned manufacturing method of device is used.

Another of the present invention is an electro-optical device that has the aforementioned device with a film.

According to the manufacturing method of the electro-optical device, high quality electro-optical device can be obtained by avoiding display inconsistencies that occur due to drying inconsistencies.

If the electro-optical device is a liquid crystal display device, said film can be used as alignment film or overcoat film.

Another aspect of the present invention is an electronic equipment that has the aforementioned electro-optical device.

According to the electronic equipment, high quality electronic equipment can be obtained by avoiding display inconsistencies that occur due to drying inconsistencies.

### BRIEF DESCRIPTION OF THE DRAWINGS

FIG. 1 is a perspective view showing the schematic configuration of thin film formation device used in the thin film formation method of the first embodiment of the present invention.

FIG. 2 shows the principles of ejection of liquid material by the piezoelectric system.

FIG. 3 is an explanatory drawing to explain the thin film formation method of the first embodiment of the present invention.

FIG. 4A and FIG. 4B are explanatory drawings to explain the thin film formation method of the first embodiment of the present invention.

FIG. 5 is a schematic view of an example of cross-section construction of a passive matrix type liquid crystal display device.

FIG. 6A, FIG. 6B, and FIG. 6C are explanatory drawings to explain the manufacturing method of passive matrix type liquid crystal display device.

FIG. 7A, FIG. 7B, and FIG. 7C are explanatory drawings to explain the manufacturing method of passive matrix type liquid crystal display device.

FIG. 8A and FIG. 8B show an example of active matrix type liquid crystal display device that uses TFT as a switching element.

FIG. 9 is a schematic view showing an example of making substrates for liquid crystal display device using large substrates, that is, for making a multiple substrate.

FIG. 10 is a cross-sectional view of active matrix type liquid crystal display device.

FIG. 11A is a perspective view showing an example of electronic equipment provided in the liquid crystal display device.

FIG. 11B is a perspective view showing an example of electronic equipment provided in the liquid crystal display device.

FIG. 11C is a perspective view showing an example of electronic equipment provided in the liquid crystal display device.

### DESCRIPTION OF EXEMPLARY EMBODIMENTS

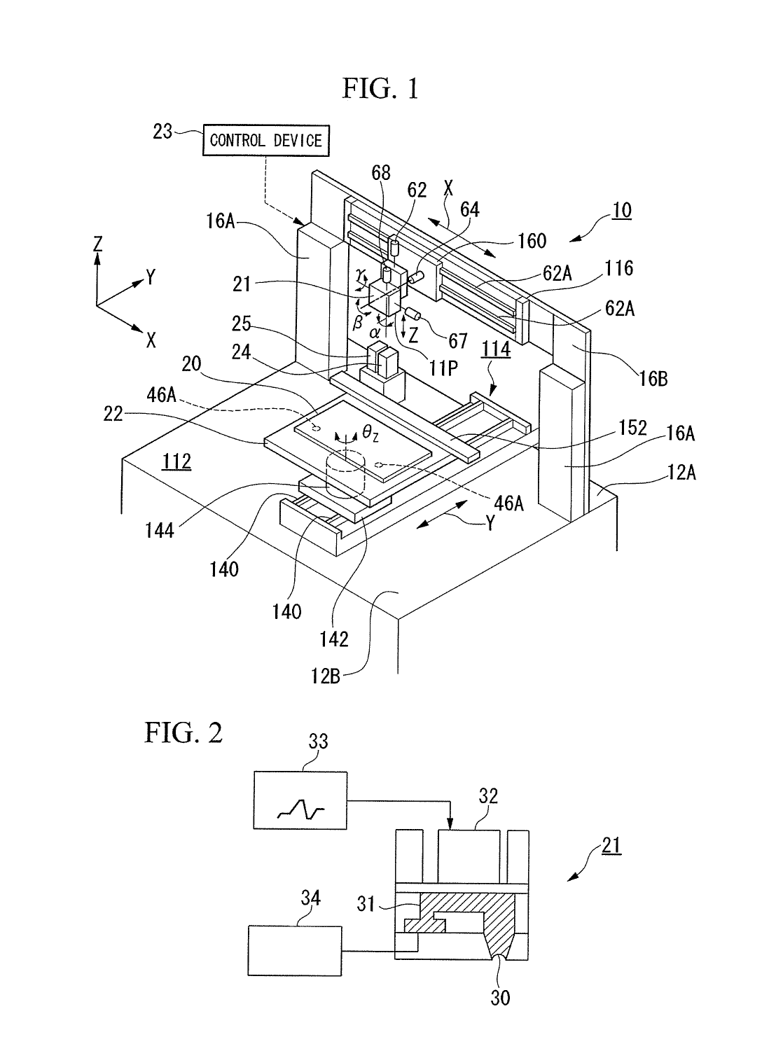

The embodiments of the device and its manufacturing method, the electro-optical device and its manufacturing method, and electronic equipment are described below referring to FIGS. 1 to 11C. The scale of each member and each layer in the drawings below has been changed appropriately to sizes that enable each member and each layer to be recognized easily.

FIG. 1 is a perspective view showing the schematic configuration of thin film formation device 10 used in the device manufacturing method of this embodiment.

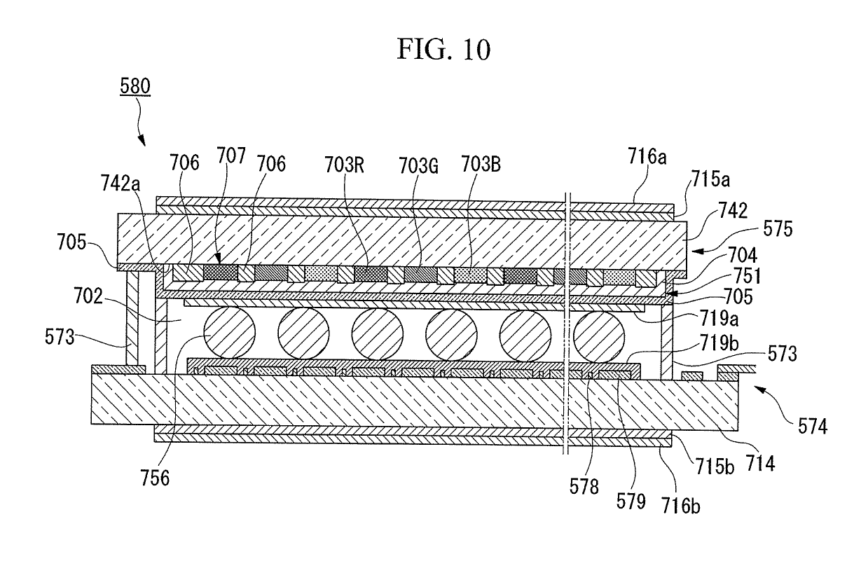

In FIG. 10, the thin film formation device 10 has: a base 112; a substrate stage 22 supporting a substrate 20, and installed on the base 112; a first drive device 114 that movably supports the substrate stage 22, and disposed between base 112 and substrate stage 22; a liquid ejection head 21 that can eject liquid for substrate 20 supported on the substrate stage 22; a second drive device 16 that movably supports the liquid ejection head 21; and a control device 23 for controlling the ejecting operation of droplets of the liquid ejection head 21. Furthermore, the thin film formation device 10 has: an electronic balance (not shown) used as a weight-measuring device and installed on base 112; a capping unit 25; and a cleaning unit 24. The operation of the thin film formation device 10 that includes the first drive device 114 and the second drive device 116, is controlled by the control device 23.

The first drive device 114 is installed on the base 112 and positioned along the Y-direction. The second drive device 116 is mounted perpendicularly with respect to the base 112 using vertical supports 16A and 16B at the rear part 12A of a base 112. The X-direction of the second drive device 116 is perpendicular to the Y-direction of the first drive device 114. The Y-direction is the same as the direction of the front part 12B and the rear part 12A of the base 112. The X-direction is the direction parallel to the left-right direction of the base 112, and both these directions lie in the horizontal plane. The Z-direction is perpendicular to both the X-direction and the Y-direction.

The first drive device 114, in case of a linear motor system, for instance, includes guide rails 140 and a slider 142 movably installed along this guide rails 140. The slider 142 of the first drive device 114 is positioned to move in the Y-direction.

The slider 142 includes a motor 144 for rotation around the Z axis (θZ). The motor 144 may be a direct drive motor, for instance. The rotor of the motor 144 is fixed on the substrate stage 22. When the motor 144 is switched on, the rotor and the substrate stage 22 rotate in the θZ direction, and the substrate stage 22 is indexed (rotary indexing). That is, the first drive device 114 enables the substrate stage to move in the Y direction and rotate in the θZ direction.

The substrate stage 22 holds the substrate 20, and positions the substrate 20 at the desired position. The substrate stage 22 has an adsorbing and holding device, not shown in the figures. When the adsorbing and holding device activates, the substrate 20 is adsorbed and held on substrate stage 22 through openings 46A of the substrate stage 22.

The second drive device 116, in case of a linear motor system for instance, includes a column 16B fixed to the supports 16A, guide rails 62A supported by the column 16B, and a slider 160 movably supported in the X-direction along the guide rails 62A. The slider 160 can be positioned along the X-direction. The liquid ejection head 21 is fitted to the slider 160.

The liquid ejection head 21 includes motors 62, 64, 67, and 68, which are oscillating and positioning devices for the liquid ejection head 21. When the motor 62 activates, the liquid ejection head 21 is moved along the Z-direction and positioned. The Z-axis is in a direction (vertical direction) perpendicular to both X-axis and Y-axis. When the motor 64 activates, the liquid ejection head 21 is oscillated in the β direction around the Y-axis and positioned. When the motor 67 activates, the liquid ejection head 21 is oscillated in the γ direction around the X-axis and positioned. When the motor 68 activates, the liquid ejection head 21 is oscillated in the α direction around the Z-axis and positioned. That is, the second drive device 116 movably supports the liquid ejection head 21 in the X-direction (direction of first drive device) and in the Z-direction, and also movably supports the liquid ejection head 21 in the θX-direction, θY-direction, and θZ-direction.

In this way, the liquid ejection head 21 of FIG. 1 can be moved in a straight line in the Z-axis direction by the slider 160 and positioned, and can also be oscillated in the α, β, and γ directions and positioned. A droplet ejection face 11P of the liquid ejection head 21 is controlled at the correct position or at the correct attitude with respect to the substrate 20 on the substrate stage 22. Multiple nozzles for ejecting liquid materials as droplets are provided on the droplet ejection face 11P of the liquid ejection head 21.

The liquid ejection head 21 ejects liquid material from the nozzles by the droplet ejection method. Related art such as the piezoelectric system for ejecting droplets (ink) using piezoelectric element as the piezoelectric actuator, the system of ejecting droplets by bubbles generated by heating the liquid material, and the like can be used as the droplet ejection method. The piezoelectric system has the advantage that it does not affect the composition of the material in any way because no heat is applied to the liquid material. The piezoelectric system is used in this embodiment.

FIG. 2 shows the principles of ejection of liquid material by the piezoelectric system. In FIG. 2, a piezoelectric actuator 32 is installed adjacent to a liquid chamber 31 containing the liquid material. The liquid material is supplied to the liquid chamber 31 through a liquid material feed system 34, which includes a material tank for storing the liquid material. The piezoelectric actuator 32 is connected to a drive circuit 33. Voltage is applied on the piezoelectric actuator 32 through the drive circuit 33. The liquid chamber 21 deforms when the piezoelectric actuator 32 deforms, and liquid material is ejected from the nozzle 30. By changing the value of the applied voltage, the distortion of the piezoelectric actuator 32 can be controlled. By changing the value of frequency of the applied voltage, the rate of distortion of the piezoelectric actuator 32 can be controlled. That is, by controlling the voltage applied on the piezoelectric actuator 32 in the liquid ejection head 21, the condition of ejection of the liquid material from the nozzle 30 can be controlled.

Returning to FIG. 1, the electronic balance (not shown) may receive, for instance, 5000 droplets from the nozzles of the liquid ejection head 21 for weighing one droplet ejected from the nozzles of the liquid ejection head 21 and for controlling the ejection. The electronic balance correctly measures the weight of one droplet of the liquid by dividing the weight of 5000 droplets by the figure 5000. The optimum quantity of droplets ejected from the liquid ejection head 21 is controlled based on the measurement of this droplet.

The cleaning unit 24 cleans the liquid ejection head 21 and the like periodically or as needed, during the device manufacturing stage or during the wait state. To ensure that the droplet ejection face 11P of the liquid ejection head 21 does not dry up, the capping unit 25 caps this droplet ejection face 11P during the wait state when the device is not manufactured.

The liquid ejection head 21 is selectively positioned above the electronic balance, the cleaning unit 24 or the capping unit 25 when the liquid ejection head 21 is moved in the X-direction by the second drive device 116. If the liquid ejection head 21 is moved to the side of the electronic balance, the weight of the droplet can be measured even during the device manufacturing work. If the liquid ejection head 21 is moved above the cleaning unit 24, the liquid ejection head 21 can be cleaned. If the liquid ejection head 21 is moved above the capping unit 25, the droplet ejection face 11P of the liquid ejection head 21 can be capped, and its drying can be prevented.

The electronic balance, the cleaning unit 24, and the capping unit 25 are disposed on the base 112 at the rear position directly below the movable path of the liquid ejection head 21 (−X side) such that they are clear of the substrate stage 22. Since the material feeding work and material removal work of the substrate 20 for the substrate stage 22 are performed at the front part of the base 112 (+X side), there is no interference with the electronic balance, the cleaning unit 24, or the capping unit 25.

As shown in FIG. 1, a reserve ejection area 152 has been provided separate from the cleaning unit 24 on the part of the substrate stage 22 other than the part supporting the substrate 20 for test or trial ejection of the droplets by the liquid ejection head 21. The reserve ejection area 152 is provided along the X-direction in the rear part of the substrate stage 22.

The reserve ejection area 152 is fixed to the substrate stage 22. It has a receiving member with a convex cross section, is interchangeably installed at the bottom of the receiving member, and has absorbing material to absorb the ejected droplets.

Various kinds of substrate made of glass, silicone, quartz, ceramics, metal, plastic, and plastic film may be used as substrate 20. Semiconductor film, metallic film, dielectric film, organic film and the like, can be formed as the primary layer on the surface of substrates made of various raw materials. Polyolefine, polyester, polyacrylate, polycarbonate, polyethersulphone, polyetherketone, and so on may be used as the plastic substrate material.

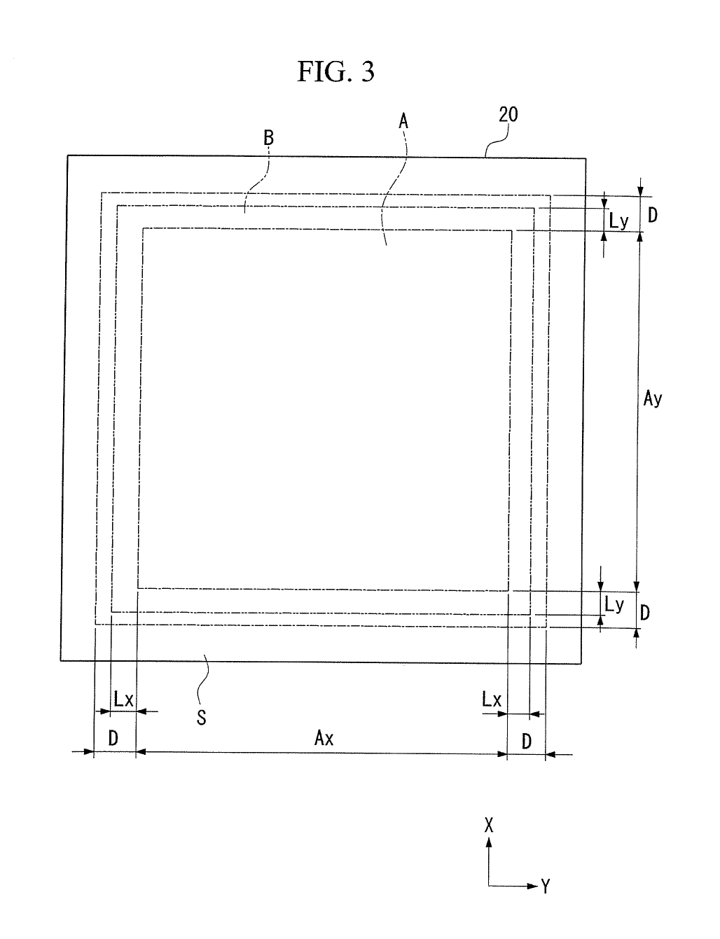

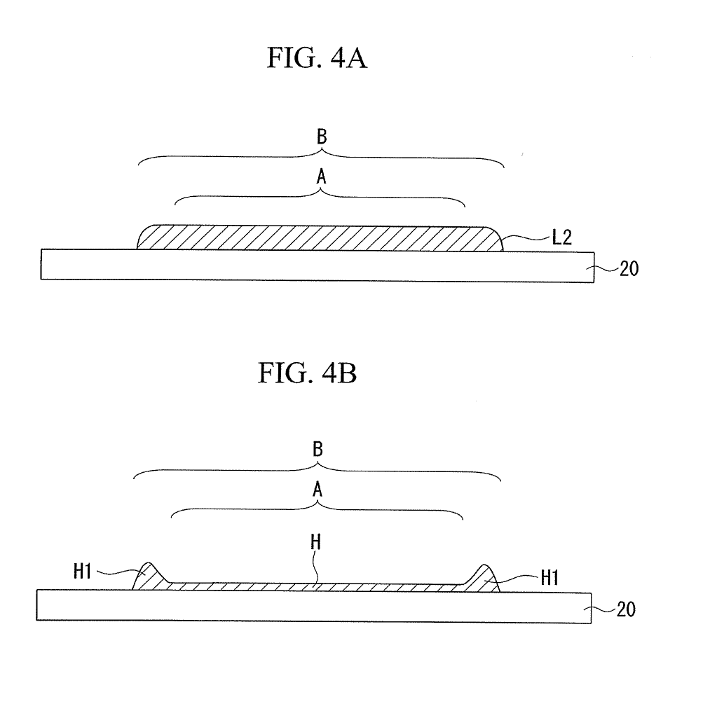

Next, the device manufacturing method of this embodiment is described referring to FIGS. 3 to 4B. In the device manufacturing method of this embodiment, thin film is formed on the substrate 20 using the aforementioned thin film formation device 10.

As shown in FIG. 3, a rectangular thin film formation region (first region) A of length Ax in the X-direction and length Ay in the Y-direction is set on the rectangular substrate 20. The thin film formation region A is a scope of functions (functional region) of thin film required by a desired function. A rectangular loop-shaped sealing part S, which is the area in which a sealing material mentioned later is to be provided, is disposed at a circumference of the substrate 20. The thin film formation region A is inside the sealing part S at a distance D from the sealing part S. That is, each side of the thin film formation region A is at a distance D from the corresponding inside edge of the sealing part S.

First, the surface of the substrate 20 is made affinity with respect to the liquid material, if required. For the liquid affinity inparting process, atmospheric pressure plasma method, UV processing method, organic thin film method (decane film, polyester film), and the like, can be used. In the plasma method, the surface of the object is made affinity or activated by exposing the surface to oxygen in plasma state. As a result, the wettability of the surface of the substrate 20 improves (for instance, the angle of contact of surface of substrate 20 which was about 70° before processing, becomes less than)20°, and enhanced uniformity in the thickness of the thin film can be obtained.

Next, as shown in FIG. 4A, liquid material L2 is ejected on the thin film formation region A including coating region (second region) B of the substrate 20, using the thin film formation device 10 (FIG. 1). As shown in FIG. 3, the coating region B is on the inside of the aforementioned sealing part, and it has a rectangular shape that covers the thin film formation region A. The length in the X direction of the coating region B is length 2*Lx (FIG. 3) longer than that of the thin film formation region A. The length in the Y direction of the coating region B is length 2*Ly (FIG. 3) longer than that of the thin film formation region A. The area of the coating region B is at least 1.3 times the area of the thin film formation region A. The coating region B is on the inside of the sealing part S and is clear of the sealing part S. That is, each side of coating region B along the X-direction is at a distance (D-Lx) from and inside the corresponding side of the sealing part S. Each side of coating region B along the Y-direction is at a distance (D-Ly) from and inside the corresponding side of the sealing part S. The thin film formation region A is inside the coating region B.

With such a liquid ejection as shown in FIG. 4A, the thin film formation region A and the boundary (outer edge) of the thin film formation region A on the substrate 20 are covered by the liquid material L2, Thus, the liquid material L2 is disposed over a coating region B that is larger than the thin film formation region A. The result is that a coating film of liquid material L2 is formed on the coating region B of the substrate 20.

Next, the liquid material film L2 disposed on the coating region B including thin film formation region A of substrate 20 is dried under predetermined drying conditions. This leads to the formation of thin film (film) H on the thin film formation region A, as shown in FIG. 4B. Since the edges of the coated film of liquid material L2 dry up faster than the central part during the drying stage, the solid content in the liquid material L2 flows toward the edges. The result is that the raised part H1 is formed at the edges of the thin film H. The raised part H1 at the edges of the thin film H is disposed on the outside of the thin film formation region A.

### EXAMPLES

The thin film formation method described above is explained with reference to an example of its use in an alignment film used in a liquid crystal display device.

As shown in Table 1, specimen 1 was manufactured with the length in the X-direction of the thin film formation region A (display region) Ax: 15 mm, length in the Y-direction Ay: 16 mm, area: 225 mm², and area of coating region B: 225 mm². Similarly, specimen 2 with coating region B with an area of 256 mm², specimen 3 with coating region B with an area of 289 mm², and specimen 4 with coating region B with an area of 339 mm² were manufactured. The display quality of specimens 1 to 4 was compared.

Alignment film requires the ability to align liquid crystals in the desired direction, voltage retention characteristics, and afterglow characteristics. It is important that the alignment film formation materials used in the liquid ejection method have minimal resistance when external force is applied on the solution and they should also possess superior flowability. As liquid included in the alignment film formation material, solutions were used containing more than 90% (here the solid content concentration was 1.6% by weight) solvent wherein the main solvent was γ-butyrolactone (boiling point: 204° C.; viscosity at 20° C.: 2 mPa·s; surface tension: 42 mN/m), taking solid content based on polyamic acid.

TABLE 1

| | | | | Area of | | |
|---|---|---|---|---|---|---|
| | | | | coating | | |
| Specimen | Solid content | | | region | Area | Display quality |
| No. | concentration | Lx (mm) | Ly (mm) | (mm²) | ratio | (inconsistency) |
| 1 | 1.6% | 0 | 0 | 225 | 1.0 | x: Inconsistency in display |
| | | | | | | part |
| 2 | 1.6% | 0.5 | 0.5 | 256 | 1.1 | x: Inconsistency in display |
| | | | | | | part |
| 3 | 1.6% | 1.0 | 1.0 | 289 | 1.3 | O: No inconsistency |
| 4 | 1.6% | 1.7 | 1.7 | 339 | 1.5 | O: Reached sealing |
| | | | | | | part |

Area of thin film formation region A: 225 mm²

As shown in Table 1, drying inconsistency occurred in the in the display region of thin films of specimens 1 and 2, which were coated (deposited) with liquid having area less than 1.3 times the area of thin film formation region A (display region), resulting in inconsistent display quality. In case of specimens 3 and 4, wherein the area ratio was greater than 1.3, uniformly dry film was formed in the display region, and no degradation in display quality (inconsistency in display) occurred. Although degradation in display quality was prevented in specimen 4, coating by droplets under these conditions was difficult since the liquid material reached the sealing part S.

Next, as shown in Table 2 and Table 3, specimens were manufactured by varying the areas of thin film formation region A (display region) with the condition that the area ratio was greater than 1.3. That is, specimen 5 was manufactured with thin film formation region A having length Ax: 8 mm in the X-direction, length Ay: 15 mm in the Y-direction, area: 120 mm² and area of coating region B: 160 mm². Similarly, specimen 6 was manufactured with thin film formation region A having length Ax: 5 mm in the X-direction, length Ay: 6 mm in the Y-direction, area: 30 mm² and area of coating region B: 42 mm².

TABLE 2

| | Solid | | | Area of | | |
|---|---|---|---|---|---|---|
| | content | | | coating | | |
| Specimen | concen- | Lx | Ly | region | Area | Display quality |
| No. | tration | (mm) | (mm) | (mm²) | ratio | (inconsistency) |
| 5 | 1.8% | 1.0 | 1.0 | 160 | 1.33 | O: No inconsistency |

Area of thin film formation region A: 120 mm²

TABLE 3

| | Solid | | | Area of | | |
|---|---|---|---|---|---|---|
| | content | | | coating | | |
| Specimen | concen- | Lx | Ly | region | Area | Display quality |
| No. | tration | (mm) | (mm) | (mm²) | ratio | (inconsistency) |
| 6 | 1.8% | 0.5 | 0.5 | 42 | 1.4 | O: No inconsistency |

Area of thin film formation region A: 30 mm²

As shown in Table 2 and Table 3, even in specimens 5 and 6 having different thin film formation region A as compared to specimen 3 and with area ratios greater than 1.3, no deterioration in display quality (inconsistency in display) was observed.

Next, specimen 7 was manufactured by varying the solid content concentration in liquid material compared to specimen 6, as shown in Table 4. In specimen 6, the solid content concentration in the ejected liquid was 1.8% by weight, and in specimen 7, the corresponding concentration was 1.6% by weight.

TABLE 4

| | Solid | | | Area of | | |
|---|---|---|---|---|---|---|
| | content | | | coating | | |
| Specimen | concen- | Lx | Ly | region | Area | Display quality |
| No. | tration | (mm) | (mm) | (mm²) | ratio | (inconsistency) |
| 7 | 1.6% | 0.5 | 0.5 | 42 | 1.4 | O: No inconsistency |

Area of thin film formation region A: 30 mm²

As shown in Table 4, when the area ratio is greater than 1.3, even in specimen 7 wherein the solid content concentration in the liquid material varied compared to that in specimen 6, no degradation in display quality (display inconsistency) was observed.

As mentioned above, film with uniformly high quality can be formed by disposing liquid having an area greater than 1.3 times the thin film formation region A, which is the scope of functions of the thin film, in the coating region B on substrate 20 in this embodiment. That is, even if a raised part is formed at the edge of the thin film, the raised part is positioned outside the thin film formation region A. Therefore, film of uniform thickness and with the desired functions can be obtained in thin film formation region A.

Since the liquid is disposed inside the sealing part S in this embodiment, the problems (such as defective joining of the substrate 20) when the liquid reaches the sealing part S, can be avoided. Furthermore, the deterioration in productivity when the conventional bank formation process is added, can also be avoided in this embodiment, and at the same time, the degradation in quality of thin film due to the dissolution of the bank member because of contact with the liquid can also be avoided.

By using the liquid ejection method in this embodiment, the desired quantity of liquid can be disposed at the desired position on the substrate 20. That is, liquid can be correctly disposed in the rectangular area having the desired shape and well inside the sealing part S on the substrate 20. Moreover, since the thin film is formed by the droplet ejection system, the quantity of the material used and the quantity of liquid removed decrease significantly compared to the flexography method or the spin coating method. Energy-saving effects are anticipated, and the substrate 20 can be increased in size easily.

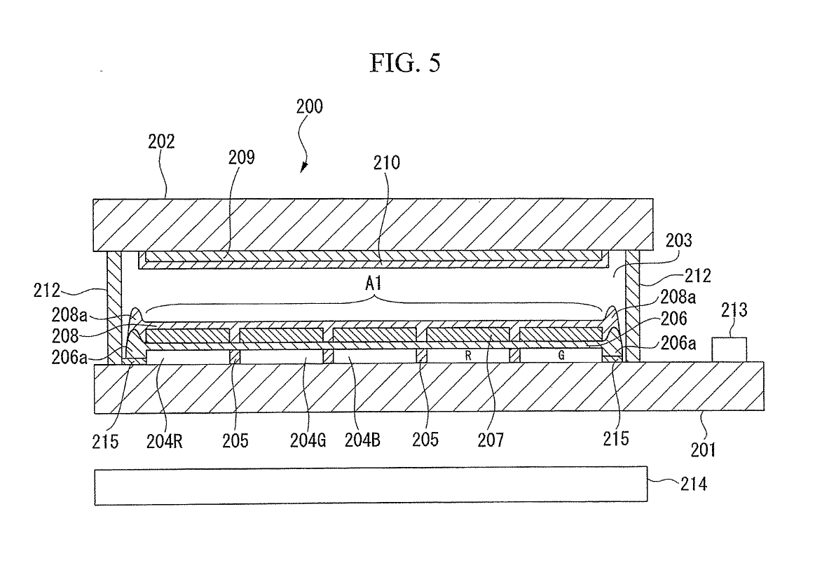

Next, the manufacturing method of the liquid crystal display device (device), which is an electro-optical device, using the device manufacturing method of this embodiment is explained referring to FIGS. 5 to 7C.

FIG. 5 is a schematic showing the cross section structure of a passive matrix type liquid crystal display device. The liquid crystal display device 200 is a transparent device, with a liquid crystal layer 203 made of Super Twisted Nematic (STN) liquid crystals sandwiched between a pair of glass substrates 201 and 202. Furthermore, a driver IC213 for supplying drive signals to the liquid crystal layer, and a backlight 214, which forms the light source, are also provided.

Color filter 204 is arranged in the glass substrate 201 compatible with its display range. The color filter 204 includes color layers 204R, 204G and 204B formed by the colors red (R), green (G) and blue (B) respectively, arranged in a regular array. A partition 205 made of black matrix or bank is formed between these color layers 204R (204G, 204B). An overcoat film 206 is provided on color filter 204 and partition 205 to flatten the level difference due to the color filter 204 and the partition 205.

Multiple electrodes 207 in striped form are formed on the overcoat film 206, on top of which alignment film 208 is formed. Multiple electrodes 209 in the form of stripes are formed on the inside face of the other glass substrate 202, such that these electrodes are orthogonal to the electrodes on the side of color filter 204 mentioned above. The alignment film 210 is formed on these electrodes 209. The color layers 204R, 204G, and 204B of the color filter 204 mentioned above, are each disposed at locations that correspond to the positions of intersection of the electrodes 209 of the glass substrate 202 and the electrodes 207 of the above-mentioned glass substrate 201. Electrodes 207 and 209 are made of a transparent conducting material such as Indium Tin Oxide (ITO). Deflecting plates (not shown) are installed on the outer face of the glass substrate 202 and color filter 204. Spacers (not shown) for maintaining fixed clearance (cell gap) between substrates 201 and 202 are provided between the glass substrates 201 and 202, and seal 212 is provided to shut off liquid crystal layer 203 from the atmospheric air. Seal 212 may be made of thermosetting resin or photo-curing resin, and disposed in the sealing part S mentioned above.

A photo shielding film 215 is formed to surround the display region A1 in the substrate 201. This photo shielding film 215 may be made of chrome or the like. The raised part 206a at the edge of the overcoat film 206, the raised parts 208a and 210a at the edge of the alignment films 208 and 210, are disposed on the photo shielding film 215 clear of the seal 212.

The above-mentioned overcoat film 206, and the alignment films 208 and 210 are formed in this liquid crystal display device 200 by the thin film formation method (device manufacturing method) mentioned above. For this reason, the thickness of the alignment films 208 and 210, and the overcoat film 206 is uniform over the display region in this liquid crystal display device 200, enabling the display performance in the liquid crystal display device 200 to be further enhanced.

Moreover, since the raised part 206a at the edge of the overcoat film 206, and the raised parts 208a and 210a at the edge of the alignment films 208 and 210, are disposed on the photo shielding film 215 in this liquid crystal display device 200, there is no need to newly provide areas for disposition of these raised parts 206a, 208a, and 210a. Thus, the thickness of the alignment films 208, 210 and the thickness of the overcoat film 206 in the display region A1 can be made uniform.

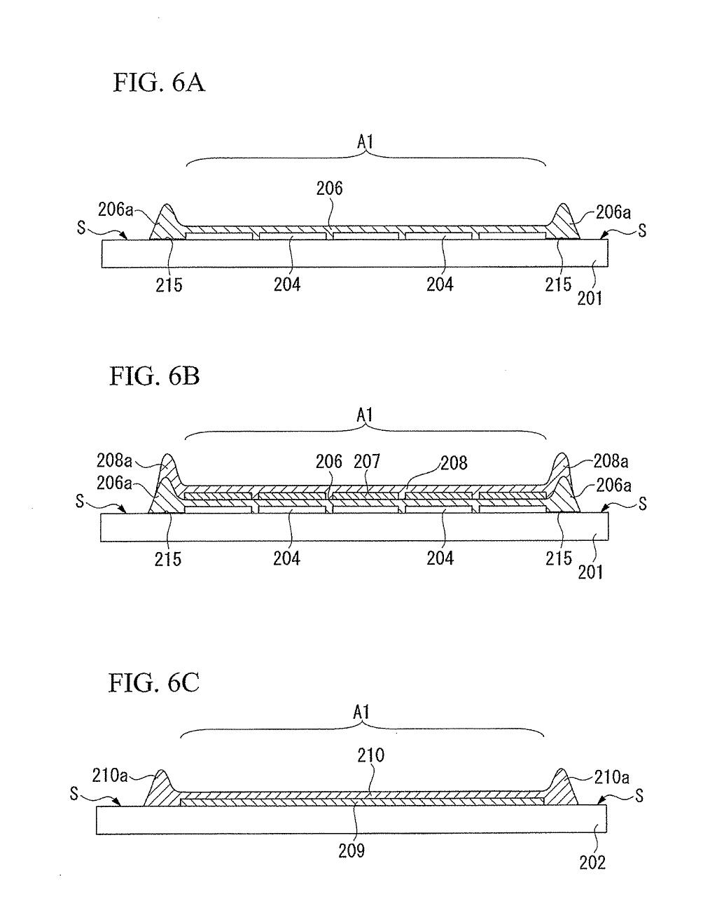

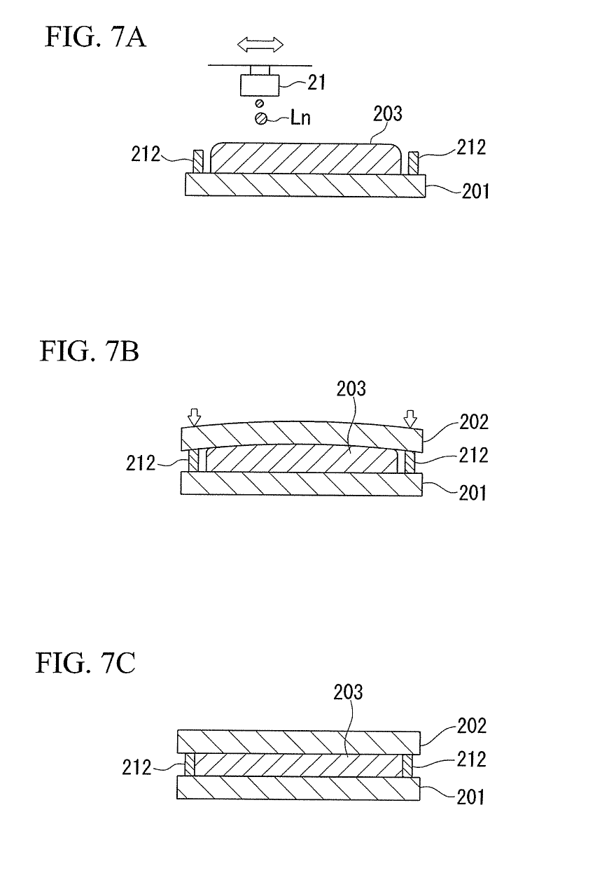

FIGS. 6A to 7C are schematic diagrams of the manufacturing method of the liquid crystal display device 200 mentioned above.

First, as shown in FIG. 6A, overcoat film 206 is formed on the substrate 201 formed by the color filter 204 and the photo shielding film 215 using the droplet ejection method. At this stage, the overcoat film 206 is formed using the thin film formation method of this embodiment mentioned above, such that the raised part 206a at the edge of the overcoat film 206 is disposed on the outside of the display region A1 and disposed on the inside of the sealing part S. By forming the overcoat film in this way, the thickness of the overcoat film 206 in the display region A1 is made uniform and the flattening in the display region A1 is enhanced.

Next, after forming the electrodes 207 on the overcoat film 206 in the display region A1, the alignment film 208 is formed in the display region A1 by the droplet ejection method, as shown in FIG. 6B. At this stage, the alignment film 208 is formed using the thin film formation method of this embodiment mentioned above, such that the raised part 208a at the edge of the alignment film 208 is disposed on the outside of the display region A1 and disposed on the inside of the sealing part S. In this way, by forming the alignment film 208, the thickness of the alignment film 208 in the display region A1 can be made uniform and the visibility in the display region A1 can be enhanced.

Next, as shown in FIG. 6C, the alignment film 210 is formed using the droplet ejection method in the area corresponding to the display region A1 above the substrate 202 on which electrodes 209 are formed. At this stage, the alignment film 210 is formed using the thin film formation method of this embodiment mentioned above such that the raised part 210 at the edge of the alignment film 210 is disposed outside the display region A1. In this way, by forming the alignment film 210, the thickness of the alignment film 210 in the display region A1 can be made uniform and the visibility in the display region A1 can be enhanced.

Subsequently, after disposing seal 212 on the substrate 201, the liquid crystal layer 203 is inserted between the substrates 201 and 202. More specifically, the desired amount of liquid crystal is quantitatively disposed on glass substrate 201, as shown in FIG. 7A, using a method such as the droplet ejection method. The desired amount of liquid crystals to be disposed on the glass substrate 201 is practically the same as the volume of the space formed between the glass substrates after sealing. The color filter, alignment film, and overcoat film have intentionally not been shown in FIG. 7A.

Next, the other glass substrate 202 is clamped down and made to adhere under reduced pressure to the glass substrate 201 on which the liquid crystal layer 203 of the desired amount is disposed, through the seal 212, as shown in FIG. 7B and FIG. 7C.

More specifically, firstly, pressure is applied mainly on the edges of the glass substrates 201 and 202 on which the seal 212 is disposed, as shown in FIG. 7B, then the seal 212, and the glass substrates 201 and 203 are bonded. After a specific period of time has elapsed and the seal 212 has dried to a certain extent, pressure is applied on the entire outer face of the glass substrates 201 and 202 so that the liquid crystal layer 203 extends over the entire space between the two substrates 201 and 202. In this case, when the liquid crystal layer 203 touches the seal 212, since the seal 212 has already dried to a certain extent, the deterioration in performance of seal 212 with the contact with liquid crystal layer 203, or the deterioration of liquid crystal layer 203 is minimal.

After the glass substrates 201 and 202 are made to adhere to each other, the seal 212 is hardened by subjecting it to heat or light, and the liquid crystal layer between the glass substrates 201 and 202 is sealed off.

The liquid crystal display device 200 shown in FIG. 5 is thus manufactured by going through the processes described above.

Although a passive matrix type liquid crystal display device is shown in FIG. 5, an active matrix type liquid crystal display device can also be made using thin film diode (TFD) and thin film transistor (TFT) as switching elements.

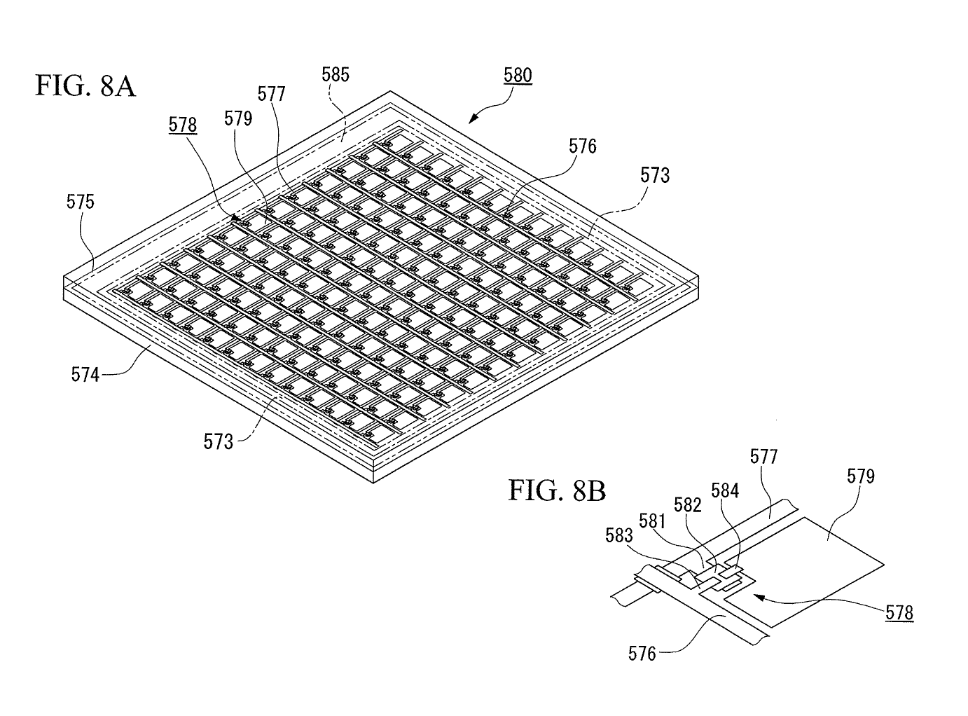

FIGS. 8A and 8B show an example of an active matrix type liquid crystal display device (liquid crystal display device) that uses TFT as the switching element. FIG. 8A shows the perspective view of the overall configuration of the liquid crystal display device in this example, while FIG. 8B is an enlarged view of a picture element in FIG. 8A.

The liquid crystal display device (device, electro-optical device) 580 shown in FIGS. 8A and 8B includes element substrate 574 formed by TFT elements and facing substrate 575 disposed to face each other. The seal 573 is disposed in framed shape between these substrates, and the liquid crystal layer (not shown) in the area is sealed by the surrounding seal 573 between the substrates.

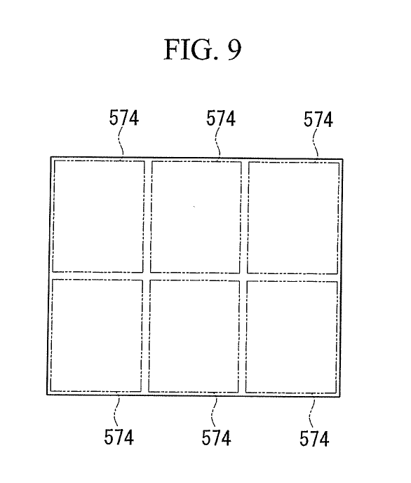

FIG. 9 is a schematic showing an example of making the above-mentioned element substrates and facing substrates for liquid crystal display device using large substrates (for instance, substrates of size 1500 mm×1800 mm), that is, making a large substrate.

The example of FIG. 9 shows the making of multiple (6 in this example) substrates (for instance, element substrate 574) from one large substrate. For each element substrate 574, TFT elements are formed, as shown in FIG. 8. Similarly in case of the facing substrate 575 shown in FIG. 8, multiple substrates can be formed from one large substrate.

Returning to FIG. 8, multiple source lines 576 and multiple gate lines 577 intersect each other to form a grid shape on the liquid crystal side surface of element substrate 574. TFT elements 578 are formed near the intersection of each source line 576 and each gate line 577. Pixel electrodes are connected through each TFT element 578, and multiple pixel electrodes 579 are disposed in matrix form in plan view. On the other hand, common electrode 585 made of transparent conducting material such as ITO compatible with the display region, is formed on the surface of the liquid crystal layer side of facing electrode 575.

As shown in FIG. 8B, TFT element 578 comprises gate electrode 581 extending from the gate line 577, insulating film (not shown in the figure) covering the gate electrode 581, semiconductor layer 582 formed on the insulating film, source electrode 583 extending from the source line 576 connected to the source area in the semiconductor layer 582, and the drain electrode 584 connected to the drain area in the semiconductor layer 582. The drain electrode 584 of the TFT element 578 is connected to the pixel electrode 579.

FIG. 10 is a cross-sectional view of active matrix type liquid crystal display device (liquid crystal display device).

The liquid crystal display device 580 includes a liquid crystal panel as the main item provided with element substrate 574 and facing substrate 575 disposed to face each other, a liquid crystal layer 702 inserted in the space between these substrates, a phase difference plate 715a fitted to the facing substrate 575, a polarizer 716a, a phase difference plate 715b fitted to the element substrate 574, and a polarizer 716b. This liquid crystal panel is attached with accessory elements such as driver chip for driving the liquid crystals, wires for transmitting electric signals, and supports, so as to achieve the desired configuration of a liquid crystal display device as the final product.

The facing plate 575 mainly includes an optically transparent substrate 742 and a color filter 751 formed on this substrate 742. Color filter 751 comprises partition 706, color layers 703R, 703G, 703B as the filter elements, and protective film 704 for covering the partition 706 and color layers 703R, 703G, 703B.

The partition 706 is a grid-shaped partition formed to enclose filter element formation area 707, which is a color layer formation area for forming each of the color layers 703R, 703G, 703B. The partition is formed on 742a, which is one face of substrate 742.

The partition 706 may be made of black photosensitive resin film, for instance. Positive or negative photosensitive resin used in normal photoresist may be used as this black photosensitive resin film, and black inorganic pigment such as carbon black, or black organic pigment at least, is included and used in this photosensitive resin film. Since this partition 706 contains black inorganic pigment or organic pigment and is formed in parts other than parts wherein color layers 703R, 703G, and 703B are formed, it can cut off the transmission of light between the color layers 703R, 703G, and 703B. Thus, the partition 706 has the function of a photo shielding film also.

The filter element materials red (R), green (G), and blue (B) are ejected by the droplet ejection method on the filter element formation area 707 provided on the inner wall of partition 706 and subsequently dried to form color layers 703R, 703G, and 703B.

An electrode layer 705 for driving liquid crystal layer made of transparent conducting material such as indium tin oxide (ITO) is formed almost over the entire surface of the protective film 704. Furthermore, alignment film 719a is provided to cover the electrode layer 705 for driving this liquid crystal layer. Alignment film 719 is also provided on pixel electrode 579 on the side of the element substrate 574.

The element substrate 574 comprises an insulating layer, not shown, which is formed on the optically transparent substrate 714, and further comprises TFT elements 578 and pixel electrodes 579, which are formed on this insulating layer. As shown in FIGS. 8A and 8B, multiple scanning lines and multiple signal lines are formed in matrix form on the insulating layer formed on the substrate 714. The pixel electrode 579 mentioned earlier, is provided in each area surrounded by these scanning lines and signal lines. The TFT element 578 is incorporated at the position where each pixel electrode 579 is electrically connected to scanning line and signal line. The TFT element 578 is switched ON or OFF by applying a signal on the scanning and signal lines to control the passage of current to the pixel electrode 579. The electrode layer 705 formed on the side of the facing substrate 575 is taken as an all-surface electrode that covers the entire picture element area of this embodiment. Various kinds of wiring circuits and pixel electrode forms may be used for TFT.

Element substrate 574 and facing substrate 575 are made to adhere to each other using the seal 573 formed along the outer edge of the facing substrate 575 through the specified clearance. Reference numeral 756 refers to a spacer for maintaining a fixed clearance in the substrate faces between the two substrates. Rectangular liquid crystal sealed areas are partitioned and formed between the element substrate 574 and facing substrate 575 by the seal 573 in frame-like pattern in plan view, and liquid crystal layer is sealed in this liquid crystal sealing area.

Even in liquid crystal display device 580 with such a configuration, the display characteristics of the liquid crystal display device 580 can be enhanced by forming the alignment films 719a and 719b by the thin film formation method of the present embodiment.

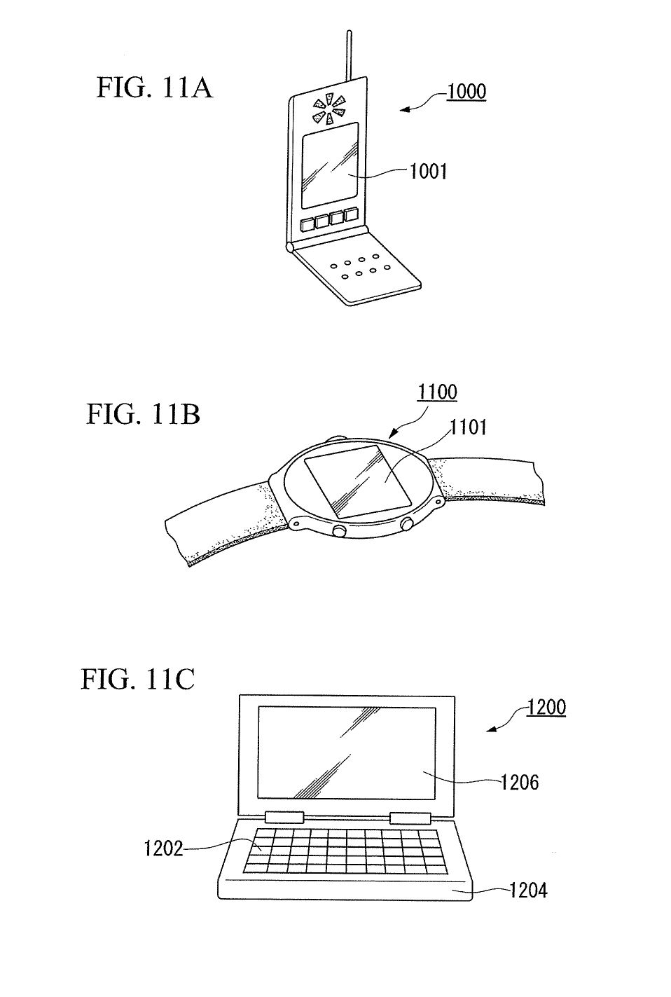

FIGS. 11A to 11C are examples of electronic equipment provided in the liquid crystal display device mentioned above. These examples of electronic equipment are provided as means for displaying the liquid crystal display device of the present invention.

FIG. 11A is a perspective view showing an example of a mobile telephone. Reference numeral 1000 in FIG. 11A indicates a mobile telephone body (electronic equipment), while reference numeral 1001 indicates the display using the liquid crystal display device mentioned above.

FIG. 11B is a perspective view showing an example of an electronic wrist watch. Reference numeral 1100 in FIG. 11B indicates the watch body (electronic equipment), while reference numeral 1101 indicates the display using the liquid crystal display device mentioned above.

FIG. 11C is a perspective view showing an example of portable information processing devices such as word processor and personal computer. The reference numeral 1200 in FIG. 11C indicates the information processing device (electronic equipment), reference numeral 1202 indicates input units such as keyboard, reference numeral 1204 indicates the body of the information processing device, and reference numeral 1206 indicates the display part using the above-mentioned liquid crystal display device.

All the electronic equipment shown in FIGS. 11A to 11C are equipped with the liquid crystal display device manufactured by using the thin film formation method of the present embodiment as the display means, and thus are electronic equipment provided with display means having high quality display characteristics.

The preferred embodiments related to the present invention have been described referring to the attached drawings as above, however, the present invention is not restricted to the examples given. The various shapes of component members or combinations thereof are examples, and various kinds of changes based on design requirements and the like may occur within the scope of the gist of the present invention.

For instance, in the aforementioned embodiment, the thin film formation region A was taken as constituting the display region, but it is not restricted to display regions only and may be used for non-display regions as well.

Also, as shown in FIG. 9, when forming multiple substrates from one large substrate, the thin film may be formed using the thin film formation method of the present invention taking one large substrate as a substrate, or it may be formed using the thin film formation method of the present invention for each substrate formed from a large substrate.

Also, alignment film and overcoat film were formed using the thin film formation method of the present invention in the aforementioned embodiment. However, the present invention is not restricted to these films only, and various kinds of thin films, such as photoresists, for instance, may be formed using the thin film formation method of the present invention.

Furthermore, the raised parts at the edges of the thin film as mentioned above, may be used as spacers or as banks during fine adjustments of the thickness of thin film. More specifically, when the raised part is used as a bank, if the liquid material is ejected and disposed at the central part of the thin film surrounded by the raised part, and this liquid material is dried, then the thickness of the thin film can be enhanced further.

What is claimed is:

1. A manufacturing method of a device having a pair of substrates fixed together with a sealing material being interposed therebetween, the manufacturing method comprising:
ejecting a liquid on one of the substrates to form a film of the liquid in a first region disposed inside of a sealing part where the sealing material is disposed,
the ejecting of the liquid including ejecting the liquid so that an edge of the film is disposed inwardly of the sealing part and outwardly of the first region after the film is dried.

2. The manufacturing method according to claim 1, wherein
the ejecting of the liquid includes ejecting the liquid so that the liquid does not enter the sealing part.

3. The manufacturing method according to claim 1, wherein
the ejecting of the liquid includes ejecting the liquid so that a raised part of the film is formed at the edge of the film at a position inward of the sealing part and outward of the first region by drying the film.

4. The manufacturing method according to claim 1, wherein
the ejecting of the liquid includes ejecting the liquid over a region of the one of the substrates having an area that is 1.3 times or larger than that of the first region.

5. The manufacturing method according to claim 1, wherein
the ejecting of the liquid includes ejecting the liquid to entirely cover the first region.

6. A manufacturing method of an electro-optical device with a film formed on a substrate, the method comprising:
forming the film by the manufacturing method according to claim 1.

7. The manufacturing method according to claim 6, wherein
the electro-optical device is a liquid crystal display device, and
the film is an alignment film.

8. The manufacturing method according to claim 6, wherein
the electro-optical device is a liquid crystal display device, and
the film is an overcoat film.

9. The manufacturing method according to claim 6, wherein
the electro-optical device is a liquid crystal display device, and
the first region is a display region of the liquid crystal display device.
